(19) United States
(12) Patent Application Publication
(10) Pub. No.: US 2017/0133742 A1
(43) Pub. Date: May 11, 2017

(54) ANTENNA ASSEMBLY AND ELECTRONIC DEVICE

(71) Applicant: Xiaomi Inc., Beijing (CN)

(72) Inventors: Wendong LIU, Beijing (CN); Wei KUANG, Beijing (CN); Youquan SU, Beijing (CN)

(21) Appl. No.: 15/343,238

(22) Filed: Nov. 4, 2016

(30) Foreign Application Priority Data
Nov. 11, 2015 (CN) 201510770242.3

(51) Int. Cl. H01Q 1/22; H01Q 7/00; H01Q 1/48; H01Q 9/04; H01Q 1/38

(52) U.S. Cl. CPC H01Q 1/2266; H01Q 9/0421; H01Q 1/38; H01Q 1/48; H01Q 7/00

(57) ABSTRACT

An antenna assembly and an electronic device are provided. The antenna assembly includes an antenna; a printed circuit board (PCB) electrically connected with the antenna through a feeding point; and a metal housing electrically connected with the antenna through a ground point.

### CROSS-REFERENCE TO RELATED APPLICATION

This application is based on and claims priority to Chinese Patent Application No. 2015107702423, filed Nov. 11, 2015, which is incorporated herein by reference in its entirety.

### FIELD

The present disclosure generally relates to the field of antenna technology, and more particularly to an antenna assembly and electronic device.

### BACKGROUND

With continuous development of electronic device manufacturing process, more and more electronic devices are provided with a full metal back cover. Compared to a traditional plastic back cover, a full metal back cover looks more beautiful and enables better tactile experience.

However, the full metal back cover will affect radiation efficiency of an antenna in an electronic device, especially in the case where an electronic device is developed toward thinner and weight lighter, because the distance between the antenna and the full metal back cover is getting smaller, the radiation efficiency of the antenna is more and more affected.

### SUMMARY

The present disclosure provides an antenna assembly and electronic device.

According to a first aspect of embodiments of the present disclosure, an antenna assembly is provided. The antenna assembly includes: an antenna; a PCB (Printed Circuit Board) electrically connected with the antenna through a feeding point; and a metal housing electrically connected with the antenna through a ground point.

According to a second aspect of embodiments of the present disclosure, an electronic device is provided. The electronic device includes the antenna assembly according to any one embodiment according to the first aspect.

It is to be understood that both the forgoing general descriptions and the following detailed descriptions are exemplary and explanatory only, and are not restrictive of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic structural view of an antenna assembly according to an exemplary embodiment of the disclosure.

FIG. 2 is a schematic structural view of an antenna assembly according to another exemplary embodiment of the disclosure.

FIG. 3 is a schematic structural view of an antenna assembly according to yet another exemplary embodiment of the disclosure.

FIG. 4 is a diagram illustrating comparison between radiation efficiency of the present antenna assembly and radiation efficiency of a traditional antenna assembly.

FIG. 5 is a schematic structural view of an electronic device according to an exemplary embodiment of the disclosure.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the disclosure. Instead, they are merely examples of devices and methods consistent with aspects related to the disclosure as recited in the appended claims.

The antenna assembly according to various embodiments of the disclosure can be used in an electronic device configured with a metal housing. The electronic device may be a smart phone, a tablet, a smart TV, an e-book reader, an MP3 (Moving Picture Experts Group Audio Layer III) player or MP4 (Moving Picture Experts Group Audio Layer IV) player, etc. The metal housing may be a seamless housing structure. For example, the metal housing may be a seamless metal back cover of a tablet. For convenience of description, the following embodiments are only illustrated by taking an antenna assembly for a tablet as an example, which is not intended to limit the disclosure.

Referring to FIG. 1, it shows a schematic structural view of an antenna assembly 100 according to an exemplary embodiment of the disclosure. The antenna assembly 100 includes: an antenna 120, a PCB 140 and a metal housing 160.

The antenna 120 and the PCB 140 are electrically connected through a feeding point 142.

The antenna 120 may be a loop antenna, an inverted F-type antenna, or a planar inverted-F antenna, etc. Further, the antenna 120 and the PCB 140 are connected through a feeder line. The disclosure does not limit the type of the antenna.

The feeding point 142 is located on the PCB 140. The PCB 140 transmits current to the antenna 120 via the feeding point 142 so that the antenna 120 generates electromagnetic radiation based on the current.

The antenna 120 and the metal housing 160 are electrically connected through a ground point 162.

The metal housing 160 may be a seamless housing structure such that current can be conducted between any two points on the metal housing 160. For example, the metal housing may be a seamless metal back cover of the tablet.

The ground point 162 is located on the metal housing 160. The metal housing 160 is electrically connected with the antenna 120 via the ground point 162, so that current flowing through the antenna 120 go through the metal housing 160. As such, the metal housing 160 forms a part of the antenna 120, and will generates resonance under effect of the current, and thereby radiation efficiency of the antenna assembly 100 can be improved.

It should be noted that, the antenna 120 includes an antenna feeding point 122 and an antenna ground point 124, and the antenna 120 is electrically connected with the feeding point 142 of the PCB 140 via the antenna feeding point 122, and is electrically connected with the ground point 162 of the metal housing 160 via the antenna ground point 124.

Thus, the antenna is electrically connected with a feeding point of the PCB and also is electrically connected with the metal housing through ground points such that the metal housing forms a part of the antenna. In this way, it avoids that the radiation efficiency of the antenna will be affected greatly as the antenna is placed closer to the full metal back cover in the case where an electronic device is developed toward thinner and weight lighter. Accordingly, radiation efficiency of the antenna is increased by directing current flowing through the antenna back to the ground via the metal housing and causing resonance of the metal housing.

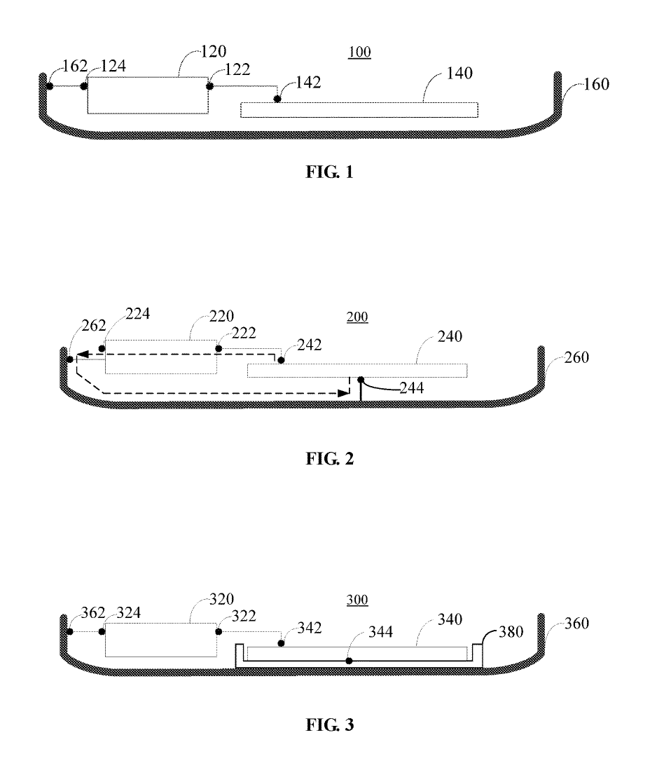

Referring to FIG. 2, it shows a schematic structural view of an antenna assembly 200 according to another exemplary embodiment of the disclosure. The antenna assembly 200 includes: an antenna 220, a PCB 240 and a metal housing 260.

The antenna 220 and the PCB 240 are electrically connected through a feeding point 242.

As shown in FIG. 2, the antenna 220 is electrically connected with the feeding point 242 of the PCB 240 via an antenna feeding point 222.

The antenna 220 and the metal housing 260 are electrically connected through a ground point 262.

As shown in FIG. 2, the antenna 220 is electrically connected with the ground point 262 of the metal housing 260 via an antenna ground point 224.

The ground point 244 of the PCB 240 is electrically connected to the metal housing 260.

Unlike the antenna assembly shown in FIG. 1, the PCB 240 is also provided with a ground point 244, through which the PCB 240 is electrically connected with the metal housing 260. The metal housing 260 directs current flowing through the antenna 220 and the metal housing 260 back to the PCB 240.

With the above described connections, when the antenna assembly 200 works, the PCB 240 transmits current to the antenna feeding point 222 of the antenna 220 via the feeding point 242. As the current flows through the antenna 220, electromagnetic radiation is generated. Since the antenna ground point 224 of the antenna 220 and the ground point 262 of the metal housing 260 are electrically connected, the current flowing through the antenna 220 flows to the metal housing 260, and then flows back to the PCB 240 through the ground point 244 connecting the metal housing 260 and PCB 240. A transmission path for the current is shown in a dotted line of FIG. 2.

Typically, an antenna ground point of the antenna and a ground point of the PCB are directly connected such that the current flowing through the antenna directly flows back to the PCB without flowing through the metal housing, and, thus the metal housing is not involved in radiation of the antenna assembly. Therefore, the radiation efficiency of the antenna is only related to the distance between the antenna and the metal housing, the smaller the distance is, the lower the radiation efficiency of the antenna is.

In the antenna assembly according to the present embodiment, however, the metal housing 260 forms a part of the antenna 220 such that radiation area of the antenna 220 is greatly increased. Under the effect of the current, the metal housing 260 generates resonance, and thereby the radiation efficiency of the antenna assembly 200 is improved significantly.

Thus, in the antenna assembly according to the present embodiment, the antenna is electrically connected with a feeding point of the PCB and also is electrically connected with the metal housing through ground points such that the metal housing forms a part of the antenna. In this way, it avoids that the radiation efficiency of the antenna will be affected greatly as the antenna is placed closer to the full metal back cover in the case where an electronic device is developed toward thinner and weight lighter. Accordingly, radiation efficiency of the antenna is increased by directing current flowing through the antenna back to the ground via the metal housing and causing resonance of the metal housing.

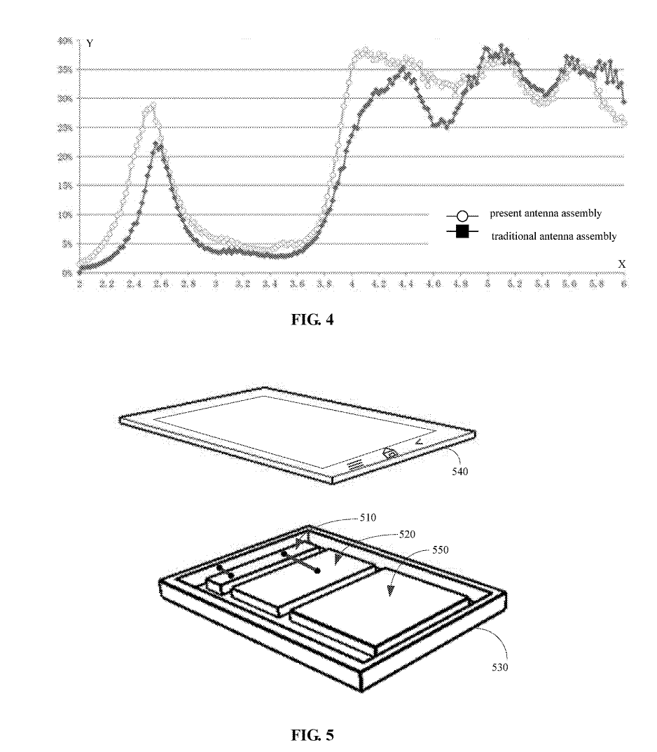

Referring to FIG. 3, it shows a schematic structural view of an antenna assembly 300 according to yet another exemplary embodiment of the disclosure. The antenna assembly 300 includes: an antenna 320, a PCB 340 and a metal housing 360.

The antenna 320 and the PCB 340 are electrically connected through a feeding point 342.

As shown in FIG. 3, the antenna 320 is electrically connected with the feeding point 342 of the PCB 340 via an antenna feeding point 322.

The antenna 320 and the metal housing 360 are electrically connected through a ground point 362.

As shown in FIG. 3, the antenna 320 is electrically connected with the ground point 362 of the metal housing 360 via an antenna ground point 324.

In order to improve stability of the antenna assembly 300 in an electronic device, the PCB 340 is fixed on an intermediary metal frame 380 and electrically connected with the intermediary metal frame 380 through a ground point 344, as shown in FIG. 3.

The intermediary metal frame 380 is fixed on the metal housing 360 and is electrically connected with the metal housing 360. The intermediary metal frame 380 may be made of an aluminum alloy material.

It should be noted that, the present embodiment is only illustrated by taking a PCB fixed on an intermediary metal frame as an example. In practice, the battery and other components of the electronic device may also be fixed on the intermediary metal frame in order to improve stability of the various components of the electronic device, which is not limited in the disclosure.

The PCB 340 transmits current to the antenna feeding point 322 of the antenna 320 via the feeding point 342, and as current flows through the antenna 320, electromagnetic radiation is generated. Since the antenna ground point 324 of the antenna 320 and the ground point 362 of the metal housing 360 are electrically connected, the current flows to the metal housing 360 after flowing through the antenna 320. The current flows through the metal housing 360, and then flows to the intermediary metal frame 380 which is electrically connected to the metal housing 360, and then flows back to the PCB 340 via the ground point 344.

Similar with the operation principle of the antenna assembly shown in FIG. 2, the metal housing 360 forms a part of the antenna 320 such that radiating area of the antenna 320 is greatly increased. Under the effect of the current, the metal housing 360 generates resonance, and thereby the radiation efficiency of the antenna assembly 300 is improved significantly.

Thus, in the antenna assembly according to the present embodiment, the antenna is electrically connected with a feeding point of the PCB and also is electrically connected with the metal housing through ground points such that the metal housing forms a part of the antenna. In this way, it avoids that the radiation efficiency of the antenna will be affected greatly as the antenna is placed closer to the full metal back cover in the case where an electronic device is developed toward thinner and weight lighter. Accordingly, radiation efficiency of the antenna is increased by directing current flowing through the antenna back to the ground via the metal housing and causing resonance of the metal housing.

Further, in the present embodiment, by fixing the PCB on the intermediary metal frame and placing the intermediary metal frame on the metal housing, not only the antenna radiation efficiency can be improved, but also stability of the PCB and other components can be ensured.

FIG. 4 illustrates comparison between radiation efficiency of the present antenna assembly and radiation efficiency of a traditional antenna assembly under the same condition (i.e. the same distance between the antenna and the metal housing), by taking WI-FI (Wireless-Fidelity) at dual-frequency of 2.4 GHz/5 GHz as an example. The X-axis in FIG. 4 represents the radiation frequency and the Y-axis in FIG. 4 represents the radiation efficiency.

In a low frequency band, since wavelength in the low frequency band is longer, the radiation efficiency of the antenna will be very low if the distance between the antenna and the metal housing is small. For example, the traditional antenna assembly has an antenna radiation efficiency of 7.5% at 2.4 GHz. With the antenna assembly according to the embodiments of the disclosure, since the metal housing forms a part of the antenna and thus is involved in radiation of the antenna due to generation of resonance, the radiation efficiency of the antenna is improved. The antenna radiation efficiency at 2.4 GHz reaches around 20%. Obviously, by using the antenna assembly according to the embodiments of the disclosure, the radiation efficiency of the antenna can be significantly improved, especially in the low frequency band.

Referring to FIG. 5, it shows a schematic structural view of an electronic device 500 according to an exemplary embodiment of the present disclosure. The electronic device 500 includes the antenna assembly shown in any one of the FIG. 1, FIG. 2 and FIG. 3. The antenna assembly includes an antenna 510, a PCB 520, and a metal housing 530.

The metal housing 530 may be a metal housing of the electronic device 500. FIG. 5 is illustrated by taking the metal housing 530 being the seamless metal back cover of the electronic device 500 as an example.

It should be noted that the electronic device 500 also include other components. For example, as shown in FIG. 5, the electronic device 500, when it is a tablet, also includes a display module 540 and a battery 550. In other possible implementations, the electronic device 500 may also include components such as sensors, physical buttons, etc, which will not be described redundantly.

Other embodiments of the disclosure will be apparent to those skilled in the art from consideration of the specification and practice of the embodiments disclosed here. This application is intended to cover any variations, uses, or adaptations of the disclosure following the general principles thereof and including such departures from the present disclosure as come within known or customary practice in the art. The specification and embodiments are merely considered to be exemplary and the substantive scope and spirit of the disclosure is limited only by the appended claims.

It should be understood that the disclosure is not limited to the precise structure as described above and shown in the figures, but can have various modification and alternations without departing from the scope of the disclosure. The scope of the disclosure is limited only by the appended claims.

What is claimed is:

1. An antenna assembly, comprising:
an antenna;
a printed circuit board (PCB) electrically connected with the antenna through a feeding point; and
a metal housing electrically connected with the antenna through a ground point.

2. The antenna assembly of claim 1, wherein the PCB has a ground point which is electrically connected to the metal housing.

3. The antenna assembly of claim 2, wherein the metal housing directs current flowing through the antenna and the metal housing back to the PCB.

4. The antenna assembly of claim 1, wherein the antenna assembly further comprises an intermediary metal frame electrically connected with both a ground point of the PCB and the metal housing.

5. The antenna assembly of claim 4, wherein the intermediary metal frame directs current flowing through the antenna and the metal housing back to the PCB.

6. The antenna assembly of claim 1, wherein the metal housing is a seamless housing structure.

7. The antenna assembly of claim 2, wherein the metal housing is a seamless housing structure.

8. The antenna assembly of claim 3, wherein the metal housing is a seamless housing structure.

9. The antenna assembly of claim 4, wherein the metal housing is a seamless housing structure.

10. The antenna assembly of claim 5, wherein the metal housing is a seamless housing structure.

11. The antenna assembly of claim 1, wherein the antenna comprises at least one of a loop antenna, an inverted F-type antenna and a planar inverted-F antenna.

12. The antenna assembly of claim 1, wherein the antenna comprises at least one of a loop antenna, an inverted F-type antenna and a planar inverted-F antenna.

13. The antenna assembly of claim 2, wherein the antenna comprises at least one of a loop antenna, an inverted F-type antenna and a planar inverted-F antenna.

14. The antenna assembly of claim 3, wherein the antenna comprises at least one of a loop antenna, an inverted F-type antenna and a planar inverted-F antenna.

15. The antenna assembly of claim 4, wherein the antenna comprises at least one of a loop antenna, an inverted F-type antenna and a planar inverted-F antenna.

16. The antenna assembly of claim 5, wherein the antenna comprises at least one of a loop antenna, an inverted F-type antenna and a planar inverted-F antenna.

17. An electronic device, comprising:
the antenna assembly of claim 1.

18. The electronic device of claim 17, wherein the metal housing is a seamless metal back cover of the electronic device.
